(19) United States
(12) Patent Application Publication
(10) Pub. No.: US 2007/0157164 A1
(43) Pub. Date: Jul. 5, 2007

(54) NETWORK BASED APPARATUS SYSTEM AND METHOD FOR DRAFTING AND VOTING ON WRITTEN WORKS

(76) Inventor: Jake Fannin, Glendale, CA (US)

Correspondence Address: MARC E. HANKIN, ESQ., 11414 THURSTON CIRCLE, LOS ANGELES, CA, 90049, US

(21) Appl. No.: 11/619,172

(22) Filed: Jan. 2, 2007

Related U.S. Application Data
(60) Provisional application No. 60/755,417, filed on Dec. 31, 2005.

(51) Int. Cl. G06F 9/44

(52) U.S. Cl. 717/110

(57) ABSTRACT

Various embodiments of this invention are directed toward an apparatus, system, and method for collaboratively drafting written works over a computer network by allowing users to vote on their preferred writers, works, and specific aspects of works, and tabulating and publishing the voting results over the computer network. In this manner, the apparatus, system, and method allows the development of final written works that represent the most popular aspects of a plurality of users' works.

### RELATED APPLICATIONS

This application claims the benefit of U.S. Provisional Application No. 60/755,417, filed on Dec. 31, 2005.

### FIELD OF INVENTION

Various embodiments of this invention are an apparatus, system, and method for drafting written works and, specifically, an apparatus, system, and method that utilize a computer based network to allow users to collaboratively draft written works, vote on their preferred works, and tabulate and display the results of the voting process.

### BACKGROUND

The development of computers and computer networking has allowed writers to use innovative means to collaborate in drafting written works. A simple computer network, for example, allows different authors to draft a written work at different times at their individual workstations in order to produce a final document that represents the cumulation of all of their respective efforts.

A more sophisticated system of producing and managing collaboratively produced documents is disclosed in U.S. Pat. No. 6,721,782 to Kasriel, et al., which assigns documents to users in a workflow system to perform specific tasks or review a document. Similarly, U.S. Pat. No. 6,473,784 to Haneda et al. discloses an apparatus that allows multiple users to input, transmit, and modify data. Another network based system for collaboration is disclosed in U.S. Pat. No. 6,094,675 to Sunaga, et al. wherein a server/client system is used to allow multiple users to discuss and collaborate on written works.

Another apparatus that allows multiple users to collaborate on written works is disclosed in U.S. Pat. No. 6,601,087 to Zhu, et al., wherein a creator of a document can distribute the document electronically to other members of a conference for their input. Another apparatus and method for shared document production is disclosed in U.S. Pat. No. 6,654,032 to Zhu, et al, which discloses a shared document that is sent to members of a data conference for their review and input. While these patents disclose systems for members of a group or office to collaborate on written works, they fail to disclose a system that may be employed over a public system, such as the Internet.

The development of the Internet has also created further opportunities for collaborative document production. U.S. Pat. No. 6,441,989, to Nagatsuka, for example, discloses an Internet based system that allows multiple users to simultaneously view and modify documents with their contributions being published to the screens of all of the users. In this manner, Nagatsuka's system allows users in multiple locations to collaborate on a single document. The system, however, fails to disclose a system that allows the quality of the users' input to be judged by other users or one to determine which contributor's work is selected for a given aspect of a work.

Meanwhile, the Internet has also allowed opportunities to poll users of websites regarding their preferences for many varieties of goods and services or for users to publish comments and opinions regarding goods, services, and other subjects. (i.e.: http://volokh.com/ for commentaries on politics and other issues http://www.scrappleface.com/ for commentaries on numerous, varied issues, http://www.iwebthereforeiam.com/comparison/blogvote.asp for commentaries on varied issues, http://simonworld.mu.nu/archives/056981.php for commentaries on varied issues, http://www.amazon.com/gp/product/customer-reviews/B00007IT2N/ref=cm_cr_dp_{—}2_{—}1/103-3687449-3009415?%5Fencoding=UTF8&s=home-garden) for reviews of books, (http://movies.yahoo.com/mvc/drv?mid=1808628231), for reviews of movies (http://www.amazon.com/gp/product/customerreviews/B000002757/ref=cm_cr_dp_{—}2_{—}1/103-3687449-3009415?%5Fencoding=UTF8&s=music), for reviews of music, http://community.netscape.com/n/pfx/forum.aspx?webtag=ws-winelovers for wine reviews, http://www.trekearth.com/gallery/Central_America/Cuba/East/Holguin/photo 102380.htm for reviews of photography, and numerous other items throughout the Internet).

Thus, through these various Internet-based services, the Internet has increased the pace with which persons are able to read and provide reviews on varied topics. However, there remains a long-felt need in the art for a network based apparatus, system, and method that allows writers to collaboratively draft documents, vote on their preferred documents and aspects of those documents, contributions, and/or writers, and tally and publish the voting results.

### DESCRIPTION OF THE INVENTION

In the following description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention. Various embodiments of the invention remain useable in tandem or combination of one another.

In the following description, certain terminology is used to describe certain features of one or more embodiments of the invention. For instance, “written work” refers to any book, novel, script, story, document, documentary, poem, prose, essay, dramatic work, journals, and further such works; “computer network” refers to any local area, large area, or Internet based network; and “computer” refers to any device that processes information with an integrated circuit chip, including without limitation, mainframe computers, work stations, servers, desktop computers, portable computers, embedded computers, wireless devices such as cellular phones, personal digital assistants, and portable game players, and hand-held computers.

This invention is directed toward overcoming the shortcomings discussed above by disclosing a network based apparatus, system, and method for collaboratively drafting written works while allowing users to vote on their preferred scenes, writers, works and specific aspects of work, and tabulating and publishing the voting results.

The network upon which the apparatus and system operates can be the Internet or any large area or local area computer network system that allows multiple users to operate the system from their respective workstations. In an alternative embodiment, the users collaborate on works from a single, central workstation that all users operate. The users' contributions, meanwhile, are stored by a central server operated as a hub for the apparatus and system. The apparatus operates equally whether operated from any of the number of workstations connected in the network. The hub, meanwhile, serves to store and tabulate the information entered from the workstations.

The apparatus operates by, first, allowing users to register with the system for different roles, such as plot writers for theatrical movie titles, writers of screenplays, illustrators of storyboards, actors, audience members, movie review writers, video or commercial producers, and further such roles, in the collaborative writing process. A given user may also operate in more than one role at any given time. Certain members, such as audience members, will serve to judge and vote on the creative works of the other users of the website. The voters, by selecting their favorite scripts, outlines for scenes, scenes, and other elements of the production, help to guide the production process because the favored scenes become included in the finalized work.

Upon registering with the system, the user is allowed several options to interact with and contribute to numerous collaborative writing efforts stored on the network's central database. These options include: suggesting a plot for a script, contributing to the draft of a script, providing illustrations or storyboards to a script, acting roles in a script, writing reviews of a script, producing a script, or further such options.

Audience members are, meanwhile, allowed to vote on the creative works. The final work represents the voters' preferences for the various aspects of the production because the voting of the preferred scenes actually dictates how the scene is incorporated into the final work. In one embodiment of the invention, the system operates by: (1) allowing a number (3-5, in one embodiment) of writers to write a scene of their own; (2) allowing the audience to vote on their favorite scene submitted by the number of writers, the favored scene being published to the finalized work; and (3) allowing the writers to proceed to write further scenes, which follow the preferred scene. In other embodiments of the invention, first, the audience votes on outlines of scenes, outlines of scripts, or various other preliminary drafts of scripts in order to determine along which plot line the script shall proceed.

Thus, in these various embodiments of the invention the voting serves as an integral portion of the creative processes by selecting the favored scenes that will make up the final work. The final work will represent the preferred scenes from each round of voting and the collaborative work of the writers of the best scenes. In this manner, the invention facilitates collaborative writing while, further, allowing the users to select among their peers' best work in order to form a final product.

Meanwhile, through a section of the apparatus dedicated to voting for award-winners, users are allowed to view the works of other users and vote for the purpose of distributing awards to the winners. This is separate from voting as part of the creative process, which is discussed in the paragraphs above. These votes or scores are tabulated by the central server, sorted, and displayed so that the most favored or popular scenes, plots, scripts, illustrations, acting, and reviews are determined by a vote and displayed as winners of the contest. Awards may also be accorded to the plots, scripts, illustrations, acting, or reviews that are determined to be the best through the voting or scoring.

Also, as an additional option for the users, they can elect to not have their collaborative works voted upon and scored or not have the votes and scoring displayed for the public to view.

The apparatus and system can include different sections for different types of collaborative writing, such as movie scripts, television scripts, television commercial scripts, play scripts, musical theater scripts, novels, music, and additional such written forms. All of these separate collaborative efforts can also be applied for adding, modifying, or interpreting existing movies and other creative works.

Auxiliary sections of the apparatus and system can provide further services such as: tutorials on script writing, resume and profile posting, commercial or classified postings, entertainment news, reviews of commercial box-office releases, information on commercial box-office releases, and such additional information commonly displayed on websites. In various embodiments of the invention, the users of the system are allowed to write plots of existing movies within the context of the voting apparatus. Following a user submission, other users vote on their favorite plot variation on an existing movie and the result is published on the site as the winner.

The apparatus and system can also operate via the Internet log information provided by the users and store the information in a central computer.

What is claimed is:

1. An apparatus and system for collaborative writing, comprising:
a plurality of computer workstations connected to one-another over a network and to a hub computer, such that data entered on the computer workstations is delivered to, accessed by, and stored by the hub computer;
the hub computer serving to store, sort, and present the data entered from the plurality of computer workstations;
the plurality of computer workstations allowing the user of the apparatus to access the system and operate as one role from the set of the following set of roles: plot writer for theatrical movies, writer of screenplays, illustrator of storyboards, actor, audience member, movie review writer, or video or commercial producer;
the plurality of computer workstations also allowing the user of the apparatus to access the system and contribute to the collaborative production of written works by performing one of the set of the following: suggesting a plot for a script, contributing to the draft of a script, drafting a script to an existing cinematic, theatrical, or other production, providing illustrations or storyboards to a script, acting roles in a script, writing reviews of a script, or producing a script;
the plurality of computer workstations also allowing the user of the apparatus to access the system and vote on or score preferred scenes, plots, scripts, illustrations, storyboards, acting, written reviews, or productions;
the hub computer serving to store, tabulate, and display the scores and votes submitted by the users.

2. The apparatus and system of claim 1, wherein the hub computer further serves to compile and present a finalized written work that represents the compilation of several individual written works that received the highest number of votes from users of the apparatus and system.

3. The apparatus and system of claim 1, wherein the network is the World Wide Web.

4. The apparatus and system of claim 1, wherein the written work is one of the written works selected from the following: books, novels, scripts, stories, documents, documentaries, poems, prose, essays, dramatic works, or journals.

5. The apparatus and system of claim 1, wherein the computer workstation is one of the computerized devices selected from the following: mainframe computers, work stations, servers, desktop computers, portable computers, embedded computers, wireless devices such as cellular phones, personal digital assistants, portable game players, or hand-held computers.

6. The apparatus and system of claim 1, wherein the computer workstations are handheld devices that are connected to one-another wirelessly.

7. The apparatus and system of claim 1, wherein a finalized written work is developed by:
a. allowing a group of writers to write alternative drafts of a first scene;
b. using the voting process to select the audience's preferred draft of the first scene;
c. using the preferred scene as the basis for drafting subsequent scenes; and
d. continuing and repeating steps (a) through (d) in order to develop subsequent scenes until all of the scenes of a finalized work are drafted.

8. An apparatus and system for collaborative writing comprising:
a computer workstation configured to store, sort, and present the data entered by several users;
the computer workstation configured to allow a user of the apparatus to access the system and operate as one role from the set of the following set of roles: plot writer for theatrical movies, writer of screenplays, illustrator of storyboards, actor, audience member, movie review writer, or video or commercial producer;
the computer workstation also configured to allow a user of the apparatus to access the system and contribute to the collaborative production of written works by performing one of the set of the following: suggesting a plot for a script, contributing to the draft of a script, drafting a script to an existing cinematic, theatrical, or other production, providing illustrations or storyboards to a script, acting roles in a script, writing reviews of a script, or producing a script;
the computer workstation configured to allow the user of the apparatus to access the system and vote on or score preferred scenes, plots, scripts, illustrations, storyboards, acting, written reviews, or productions; and
the computer workstation serving to store, tabulate, and display the scores and votes submitted by the users.

9. A method for collaboratively drafting written works, comprising:
connecting a plurality of computer workstations to one-another over a network and to a hub computer, such that data entered on the computer workstations is delivered to, accessed by, and stored by the hub computer; the hub computer being configured to store, sort, and present the data entered from the plurality of computer workstations;
allowing the user of the apparatus to access the system over the plurality of computer workstations such that they may operate as one role from the set of the following set of roles: plot writer for theatrical movies, writer of screenplays, illustrator of storyboards, actor, audience member, movie review writer, or video or commercial producer;
allowing the user of the apparatus to access the system from the plurality of computer workstations and contribute to the collaborative production of written works by performing one of the set of the following: suggesting a plot for a script, contributing to the draft of a script, drafting a script to an existing cinematic, theatrical, or other production, providing illustrations or storyboards to a script, acting roles in a script, writing reviews of a script, or producing a script;
allowing the user of the apparatus to access the system from the plurality of computer workstations to vote on or score preferred scenes, plots, scripts, illustrations, storyboards, acting, written reviews, or productions;
configuring the hub computer serving to store, tabulate, and display the scores and votes submitted by the users.

10. The method for collaboratively drafting written works of claim 9, further comprises the hub computer compiling and presenting a finalized written work that represents the compilation of several individual written works that received the highest number of votes from users of the apparatus and system.

11. The method for collaboratively drafting written works of claim 9, wherein the network is the World Wide Web.

12. The method for collaboratively drafting written works of claim 9, wherein the written work is one of the written works selected from the following: books, novels, scripts, stories, documents, documentaries, poems, prose, essays, dramatic works, or journals.

13. The method for collaboratively drafting written works of claim 9, wherein the computer workstation is one of the computerized devices selected from the following: mainframe computers, work stations, servers, desktop computers, portable computers, embedded computers, wireless devices such as cellular phones, personal digital assistants, portable game players, or hand-held computers.

14. The method for collaboratively drafting written works of claim 9, wherein the computer workstations are handheld devices that are connected to one-another wirelessly.

15. The method for collaboratively drafting written works of claim 9, wherein the finalized written work is developed by:
a. allowing a group of writers to write alternative drafts of a first scene;
b. using the voting process to select the audience's preferred draft of the first scene;
c. using the preferred scene as the basis for drafting subsequent scenes; and
d. continuing and repeating steps (a) through (d) in order to develop subsequent scenes until all of the scenes of a finalized work are drafted.
